(19) United States
(12) Patent Application Publication
(10) Pub. No.: US 2007/0243906 A1
(43) Pub. Date: Oct. 18, 2007

(54) Mobile communication device

(75) Inventor: Jonathan Biddle, Taipei (TW)

Correspondence Address: BIRCH STEWART KOLASCH & BIRCH, PO BOX 747, FALLS CHURCH, VA, 22040-0747, US

(73) Assignee: Hsueh-Ling CHANG

(21) Appl. No.: 11/704,193

(22) Filed: Feb. 9, 2007

(30) Foreign Application Priority Data
Apr. 14, 2006 (TW) 95206351

(51) Int. Cl. H04B 1/38

(52) U.S. Cl. 455/566

(57) ABSTRACT

A mobile communication device includes a housing and a LCM (liquid crystal module). The LCM is sited on a roof section of an outer surface of the housing. The LCM can display time, incoming calls, pictures, etc. and let the mobile communication device be convenient to operate.

### FIELD OF THE INVENTION

The present invention relates to a mobile communication device, more particularly to a LCM (Liquid Crystal Module) sited on a roof section of an outer surface of the housing.

### BACKGROUND OF THE INVENTION

With the widespread usage of the mobile communication device, the marketing has made that the mobile communication device has being added versatile functions, such as multimedia, wireless, games, multi-point communications, etc. Therefore, in addition to various functions, the appearance of the mobile communication device is an attraction for the consumers.

For the appearance, the design of the mobile communication device tends to lightness and smallness for being carried conveniently. Generally speaking, the mobile communication device is often put into the sheath or next to the waist of a user. Because conventionally a display window is disposed on a side surface of the mobile communication device, if the user wants to check the incoming calls or the contents of mp3 songs shown on the display window, the mobile communication device should be taken out from the sheath and therefore it causes the inconvenience.

Referring to FIG. 1, which illustrates a schematic front elevation view of a flip mobile communication device in prior arts. The mobile communication device 1 includes an upper housing 10, a lower housing 11, a keyboard 12, an inner screen 13a, and an outer screen 13b. Both tops of the upper housing 10 and the lower housing 11 are connected each other by a hinge located on both sides of the tops. The keyboard 12 is sited on an inner surface of the lower housing 11 for inputting related data and making phone calls. The inner screen 13a is disposed on an inner surface of the upper housing 10, and the outer screen 13b is sited on an outer surface of the upper housing 10. The inner screen 13a is for browsing the operation processes, and the outer screen 13b is for indicating time, signal power, and the incoming calls.

However, design of the outer screens of the conventional flip mobile phones is different from the commercial needs. The outer screen is almost sited on the outer surface of the housing. Hence it is inconvenient that the mobile phone must be taken out from the sheath for browsing the information shown on the outer screen.

The inconvenience completely describes that the design for the outer screen disposed on the side of the upper housing is not appropriate. Therefore, obviously, it is an important issue to relocate the position of the outer screen for solving the inconvenience, and the way of relocation may then be described as follows.

### SUMMARY OF THE INVENTION

The objective of the present invention is to provide a mobile communication device, and a LCM is disposed on a roof section of an outer surface of a housing of the mobile communication device.

This invention of the mobile communication device comprises a housing and a LCM, wherein the LCM is disposed on a roof section of an outer surface of the housing. The mobile communication device is a flip mobile communication device. The housing is composed of an upper housing and a lower housing, and the upper housing can cover the lower housing, and the LCM is disposed on a top edge of the upper housing. Besides, the mobile communication device further comprises a hinge sited on a top edge of the lower housing, and the hinge is connected to an upper portion of an inner surface of the upper housing.

The mobile communication device is also a slide mobile communication device. The housing is composed of an upper housing and a lower housing, and the LCM is disposed on a top edge of the upper housing.

Further, the LCM can display time, incoming calls, and pictures etc. The mobile communication device further comprises a belt for wrapping around a surface of the housing, and the belt comprises at least a LED (Light Emitted Diode) inside.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 illustrating a schematic front elevation view of a flip mobile communication device in prior arts;

FIG. 2a illustrating a schematic rear elevation view of a first preferred embodiment of a mobile phone of the present invention;

FIG. 2b illustrating a schematic front elevation view of the first preferred embodiment of the mobile phone of the present invention;

FIG. 2c illustrating a schematic rear view of the first preferred embodiment of the mobile phone of the present invention;

FIG. 2d illustrating a top elevation view of the first preferred embodiment of the mobile phone of the present invention; and

FIG. 3 illustrating a schematic front elevation view of a second preferred embodiment of the mobile phone of the present invention.

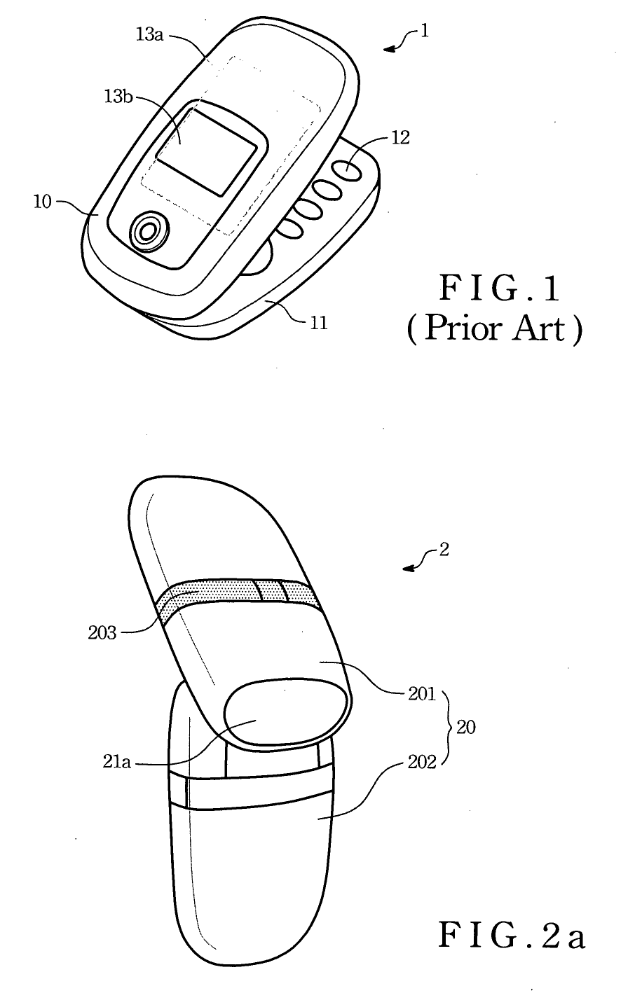

### DETAILED DESCCRIPTIONS OF THE PREFERRED EMBODIMENT

The present invention discloses a mobile communication device, and more particularly to a mobile communication device having a LCM sited on a roof section of an outer surface of a housing.

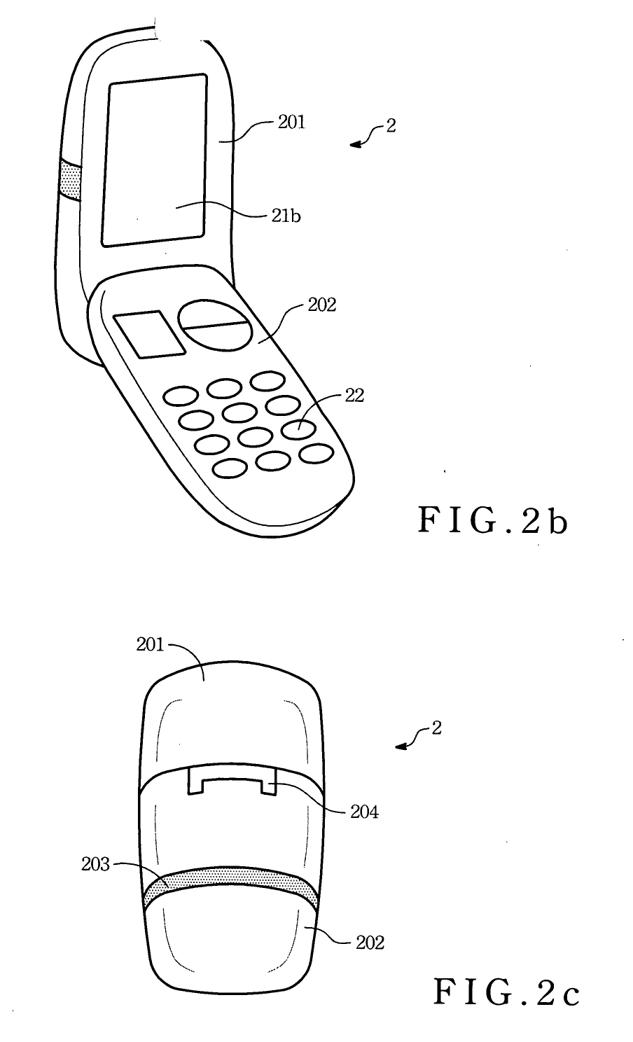

Referring to FIG. 2a˜2d simultaneously, which illustrate a schematic rear elevation view of a first preferred embodiment of a mobile phone of the present invention, a schematic front elevation view of the first preferred embodiment of the mobile phone of the present invention, a schematic rear view of the first preferred embodiment of the mobile phone of the present invention, and a top elevation view of the first preferred embodiment of the mobile phone of the present invention. The mobile communication device 2 includes a housing 20 and a LCM 21a, wherein the LCM 21a is disposed on a roof section of an outer surface of the housing 20. In this embodiment, the mobile communication device 2 is a flip mobile phone. The housing 20 is composed of an upper housing 201 and a lower housing 202, the upper housing 201 can cover the lower housing 202, and the LCM 21a is disposed on a top edge of the upper housing 201. Besides, the mobile phone further includes a hinge sited on a top edge of the lower housing, and the hinge is connected to an upper portion of an inner surface of the upper housing. A set of the keyboard 22 is sited on an inner surface of the lower housing 202 for inputting the related data of the mobile phone 2 and making phone calls. A LCM 21b is sited on an inner surface of the upper housing 201 for browsing the operation processes and the functions of the mobile phone 2.

It is to be noted that a top of the upper housing 201 has a protrusion where on the LCM 21a is sited. Besides, for adding artistry of the mobile phone 2, a hinge 204 is sited on a top edge of the lower housing 202, and the hinge 204 is connected to an upper portion of an inner surface of the upper housing 201. In another word, a top of the lower housing 202 is connected to a depression of the upper housing 201. Hence, the LCM 21a has a greater room, and the LCM 21a can be disposed on the top of the upper housing 201, and the connected design of the upper housing 201. The connection of the upper housing 201 and the lower housing 202 is able to meet the conditions of the good-looking appearance and the smaller thickness.

Further, the LCM 21a is used for displaying time, incoming calls, the titles or lyrics of songs, pictures, etc. The mobile phone 2 further includes a belt 203 for wrapping around a surface of the housing 20, and the belt comprises a plurality of LED (Light Emitted Diode) s inside making different colors of light for fashion. The colors of the belt 203 are customized. The colors are integrated with the housing 20 so as to exhibit a fantastic appearance.

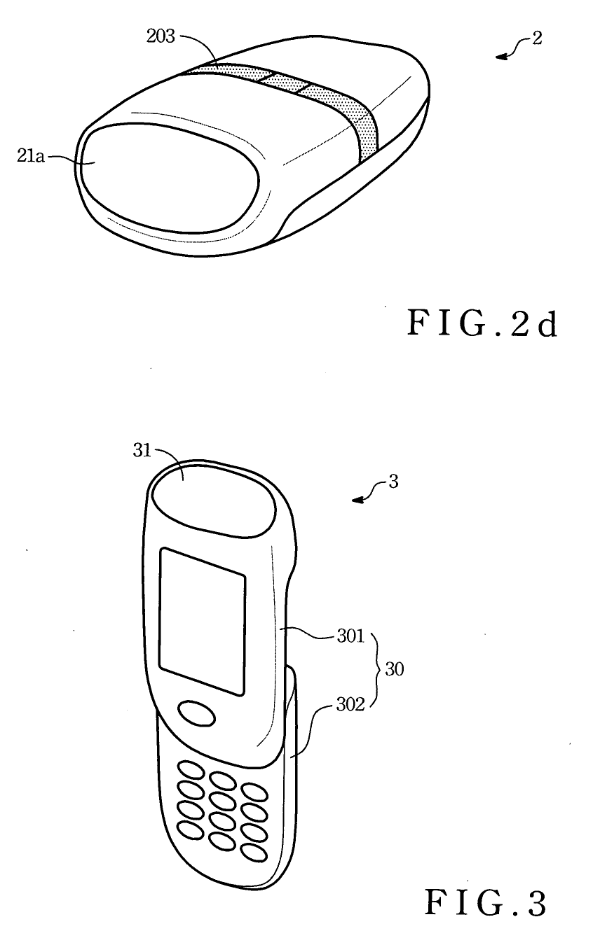

Further referring to FIG. 3, which illustrate a schematic front elevation view of a second preferred embodiment of the mobile phone of the present invention. The mobile phone 3 is a slide phone and includes a housing 30 and a LCM 31. The LCM 31 is sited on a top edge of an outer surface of the housing 301. The housing 30 has an upper housing 301 and a lower housing 302, and the LCM 31 is sited on a top edge of the upper housing 301.

As a conclusion, the mobile phone of the present invention is different from prior arts, that is, the LCM is located on the roof section of the outer surface of the housing. The merit of the design is to avoid the action of taking the mobile phone from the sheath while the user may browse the shown information as time, signals, incoming calls, the title or lyrics of the songs, pictures, etc. or dial out in order to increase the convenience to operate the mobile phone.

As is understood by a person skilled in the art, the foregoing preferred embodiment of the present invention is illustrated of the present invention rather than limiting of the present invention. It is intended to cover various modifications and similar arrangements included within the spirit and scope of the appended claims, the scope of which should be accorded the broadest interpretation so as to encompass all such modifications and similar design.

What is claimed is:

1. A mobile communication device comprising:
a housing; and
a LCM (Liquid Crystal Module) disposed on a roof section of an outer surface of the housing for being viewed from top directly.

2. The mobile communication device according to claim 1, wherein said mobile communication device is a flip mobile communication device.

3. The mobile communication device according to claim 2, wherein said housing is composed of an upper housing and a lower housing, and the upper housing covers the lower housing.

4. The mobile communication device according to claim 3, wherein said LCM is disposed on a top edge of the upper housing.

5. The mobile communication device according to claim 2 further comprising a hinge sited on a top edge of the lower housing, wherein the hinge is connected to an upper portion of an inner surface of the upper housing.

6. The mobile communication device according to claim 1, wherein said mobile communication device is a slide mobile communication device.

7. The mobile communication device according to claim 6, wherein said housing is composed of an upper housing and a lower housing, and said LCM is disposed on a top edge of the upper housing.

8. The mobile communication device according to claim 1, wherein said LCM is used for displaying time, incoming calls, and pictures.

9. The mobile communication device according to claim 1 further comprising a belt for wrapping around a surface of the housing, wherein the belt comprises at least a LED ( Light Emitted Diode) inside.
